(19) United States
(12) Patent Application Publication
(10) Pub. No.: US 2017/0139536 A1
(43) Pub. Date: May 18, 2017

(54) FDM BASED CAPACITIVE TOUCH SYSTEM AND OPERATING METHOD THEREOF

(71) Applicant: PIXART IMAGING INC., Hsin-Chu County (TW)

(72) Inventors: Hsin-Chia CHEN, Santa Clara, CA (US); Kenneth CRANDALL, Santa Clara, CA (US); Raman SAHGAL, Santa Clara, CA (US)

(21) Appl. No.: 14/941,256

(22) Filed: Nov. 13, 2015

(51) Int. Cl. G06F 3/041; G06F 3/044

(52) U.S. Cl. CPC G06F 3/0418; G06F 3/044

(57) ABSTRACT

A capacitive touch system including a capacitive touch panel, a storage element and a control chip is provided. The storage element is configured to store a lookup table which contains a plurality of mixing signals. The control chip concurrently drives the capacitive touch panel with a plurality of frequency division multiplexed drive signals to generate a plurality of detection signals, and determine a plurality pairs of mixing signals according to the lookup table for respectively modulating the detection signals to generate a plurality pairs of modulated detection signals, wherein the pair of mixing signals corresponding to different drive signals are different from one another.

### BACKGROUND

1. Field of the Disclosure

This disclosure generally relates to a touch system and, more particularly, to a frequency division multiplexing based capacitive touch system and an operating method thereof.

2. Description of the Related Art

Capacitive sensors generally include a pair of electrodes configured to sense a conductor. When the conductor is present, the amount of charge transfer between the pair of electrodes can be changed so that it is able to detect whether the conductor is present or not according to a voltage variation. It is able to form a sensing matrix by arranging a plurality of electrode pairs in a matrix.

FIGS. 1A and 1B show schematic diagrams of a conventional capacitive sensor which includes a first electrode 91, a second electrode 92, a drive circuit 93 and a detection circuit 94. The drive circuit 93 is configured to input a drive signal to the first electrode 91. Electric field can be generated between the first electrode 91 and the second electrode 92 so as to transfer charges to the second electrode 92. The detection circuit 94 is configured to detect the amount of charge transfer to the second electrode 92.

When a conductor is present, e.g. shown by an equivalent circuit 8, the conductor can disturb the electric field between the first electrode 91 and the second electrode 92 so that the amount of charge transfer is reduced. The detection circuit 94 can detect a voltage variation to accordingly identify the presence of the conductor.

As the capacitive sensor is generally applied to various electronic devices, e.g. liquid crystal display (LCD), the voltage variation detected by the detection circuit 94 can be interfered by the noise of the electronic devices to degrade the detection accuracy.

Accordingly, it is necessary to provide a way to solve the above problem.

### SUMMARY

The present disclosure provides a capacitive touch system and an operating method thereof that concurrently drive different channels by different drive signals of different drive frequencies so as to reduce the noise interference.

The present disclosure further provides a capacitive touch system and an operating method thereof that modulate detection signals of different channels respectively with different two orthogonal signals selected from a lookup table and detect a touch event according to a norm of vector of two modulated signals.

The present disclosure provides a capacitive touch system including a plurality of drive electrodes, a plurality of receiving electrodes, a plurality of drive circuits, a plurality of detection circuits and a processing unit. The drive electrodes and the receiving electrodes are configured to form a plurality of sensing elements therebetween. The drive circuits are respectively coupled to the drive electrodes and configured to concurrently output a plurality of drive signals to the drive electrodes, wherein a plurality of drive frequencies of the drive signals outputted by different drive circuits are different from one another. The detection circuits are respectively coupled to the receiving electrodes. Each of the detection circuits includes two mixers configured to modulate a detection signal outputted by the coupled receiving electrode with a pair of mixing signals to generate a pair of modulated detection signals. The processing unit is configured to determine the pair of mixing signals corresponding to each of the detection circuits according to the drive frequencies, and calculate a norm of vector of the pair of modulated detection signals to accordingly identify a touch event.

The present disclosure further provides a capacitive touch system including a capacitive touch panel, a storage element and a control chip. The storage element is configured to previously store a plurality of mixing signals. The control chip is configured to concurrently drive the capacitive touch panel with a plurality of frequency division multiplexed drive signals to output a plurality of detection signals, and read a plurality pairs of mixing signals from the storage element to respectively modulate the detection signals to generate a plurality pairs of modulated detection signals, wherein the pair of mixing signals corresponding to different drive signals are different from one another.

The present disclosure further provides an operating method of a capacitive touch system. The capacitive touch system includes a plurality of drive electrodes, a plurality of receiving electrodes, a plurality of drive circuits, a plurality of detection circuits and a processing unit. The operating method includes the steps of:

providing, by the drive circuits, a plurality of drive signals to the drive electrodes, wherein at least a part of a plurality of drive frequencies of the drive signals outputted by different drive circuits are different from one another; modulating, by each of the detection circuits, a detection signal outputted by the coupled receiving electrode with a pair of mixing signals to generate a pair of modulated detection signals; and determining, by the processing unit, the pair of mixing signals corresponding to each of the detection signals according to the drive frequencies.

### BRIEF DESCRIPTION OF THE DRAWINGS

Other objects, advantages, and novel features of the present disclosure will become more apparent from the following detailed description when taken in conjunction with the accompanying drawings.

FIGS. 1A-1B are schematic diagrams of a conventional capacitive sensor.

FIG. 2 is a schematic block diagram of a capacitive touch sensing device according to an embodiment of the present disclosure.

FIGS. 3A-3B are schematic diagrams of a capacitive touch sensing device according to some embodiments of the present disclosure.

FIG. 4 is a schematic diagram of the norm of vector and the threshold according to an embodiment of the present disclosure.

FIG. 5 is a schematic diagram of a capacitive touch system according to a first embodiment of the present disclosure.

FIG. 6 is a block diagram of a capacitive touch system according to a second embodiment of the present disclosure.

FIG. 7 is an operational schematic diagram of a capacitive touch system according to a second embodiment of the present disclosure.

FIG. 8 is another block diagram of a capacitive touch system according to a second embodiment of the present disclosure.

FIG. 9 is an alternative block diagram of a capacitive touch system according to a second embodiment of the present disclosure.

FIG. 10 is a lookup table for a capacitive touch system according to a second embodiment of the present disclosure.

FIG. 11 is an index table of mixing signals corresponding to different drive frequencies in a capacitive touch system according to a second embodiment of the present disclosure.

FIG. 12 is a flow chart of a capacitive touch system according to a second embodiment of the present disclosure.

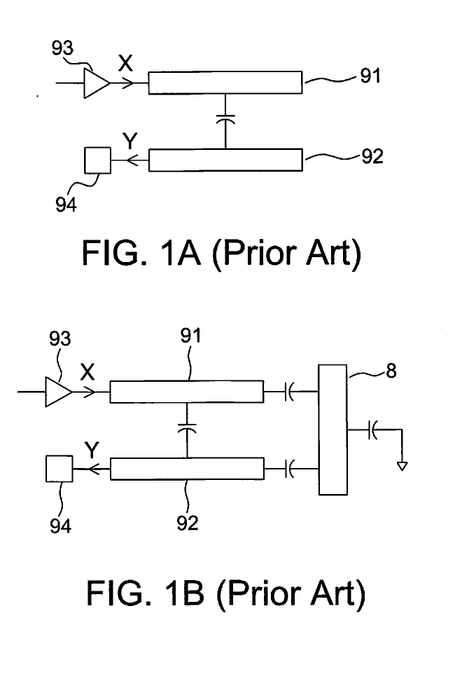

### DETAILED DESCRIPTION OF THE EMBODIMENT

It should be noted that, wherever possible, the same reference numbers will be used throughout the drawings to refer to the same or like parts.

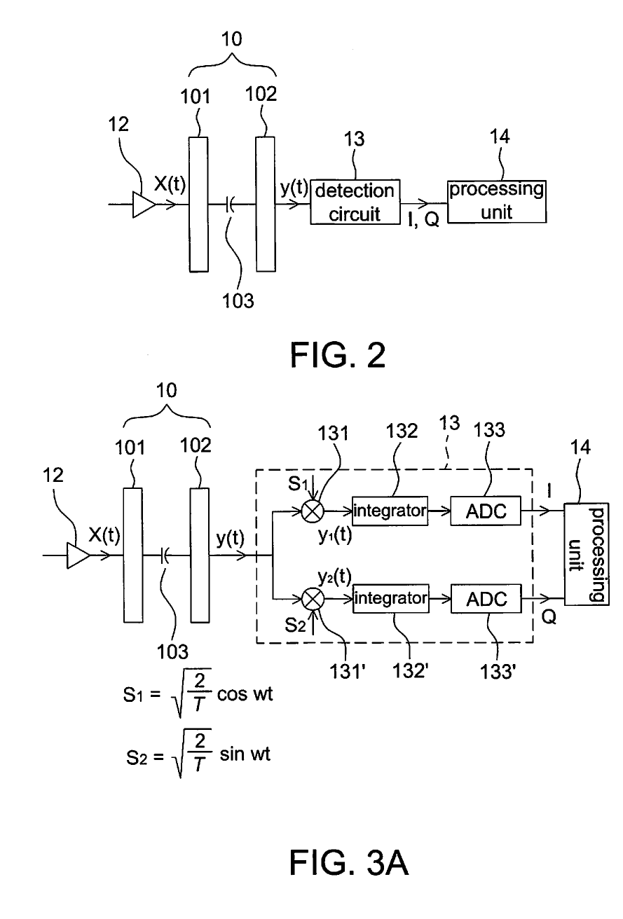

Referring to FIG. 2, it is a schematic block diagram of a capacitive touch sensing device according to an embodiment of the present disclosure. The capacitive touch sensing device of this embodiment includes a sensing element 10, a drive circuit 12, a detection circuit 13 and a processing unit 14. The capacitive touch sensing device is configured to detect whether an object (e.g. a finger, water drop or metal plate, but not limited to) approaches the sensing element 10 according to a change of the amount of charges on the sensing element 10. Ways to detect whether the object approaches the sensing element 10 are well known and not limited to the above method.

The sensing element 10 includes a first electrode 101 (e.g. a drive electrode) and a second electrode 102 (e.g. a receiving electrode), and an electric field can be produced to form a coupling capacitance 103 between the first electrode 101 and the second electrode 102 when a voltage signal is provided to the first electrode 101. The first electrode 101 and the second electrode 102 are arranged properly without particular limitations as long as the coupling capacitance 103 is formed (e.g. via a dielectric layer), wherein principles of forming the electric field and the coupling capacitance 103 between the first electrode 101 and the second electrode 102 are well known to the art and thus are not described herein.

The drive circuit 12 is, for example, a signal generator and configured to provide a drive signal x(t) to the first electrode 101 of the sensing element 10. The drive signal x(t) is, for example, a time-varying signal such as a periodic signal. In other embodiments, the drive signal x(t) is, for example, a pulse signal such as a square wave or a triangle wave, but not limited thereto. The drive signal x(t) couples a detection signal y(t) on the second electrode 102 of the sensing element 10 through the coupling capacitance 103.

The detection circuit 13 is coupled to the second electrode 102 of the sensing element 10 and configured to receive the detection signal y(t). The detection circuit 13 modulates (or mixes) the detection signal y(t) respectively with two mixing signals so as to generate a pair of modulated detection signals I and Q, which are served as two components of a two-dimensional detection vector (I,Q). The two mixing signals are, for example, continuous signals or vectors that are orthogonal or non-orthogonal to each other. In one aspect, the two mixing signals include a sine signal and a cosine signal.

The processing unit 14 is configured to calculate a scale of the pair of modulated detection signals, which is served as a norm of vector of the two-dimensional detection vector (I,Q), and compare the norm of vector with a threshold TH so as to identify a touch event. In one aspect, the processing unit 14 calculates the norm of vector R=\sqrt{I²+Q²} by software. In other aspect, the processing unit 14 calculates the norm of vector by hardware or firmware, such as using the CORDIC (coordinate rotation digital computer) shown in FIG. 4 to calculate the norm of vector R=\sqrt{I²+Q²}, wherein the CORDIC is a fast algorithm. The processing unit 14 is, for example, a microprocessor (MCU), a central processing unit (CPU) or an application specific integrated circuit (ASIC).

In FIG. 4, when there is no object closing to the sensing element 10, the norm of vector calculated by the processing unit 14 is assumed to be R; and when an object is present nearby the sensing element 10, the norm of vector is decreased to R′. If the norm of vector R′ is smaller than a threshold TH, the processing unit 14 identifies that the object is present close to the sensing element 10 to induce a touch event. It should be mentioned that when another object, such as a metal plate, approaches the sensing element 10, the norm of vector R can be increased. Therefore, it is possible for the processing unit 14 to identify a touch event when the norm of vector becomes larger than another predetermined threshold.

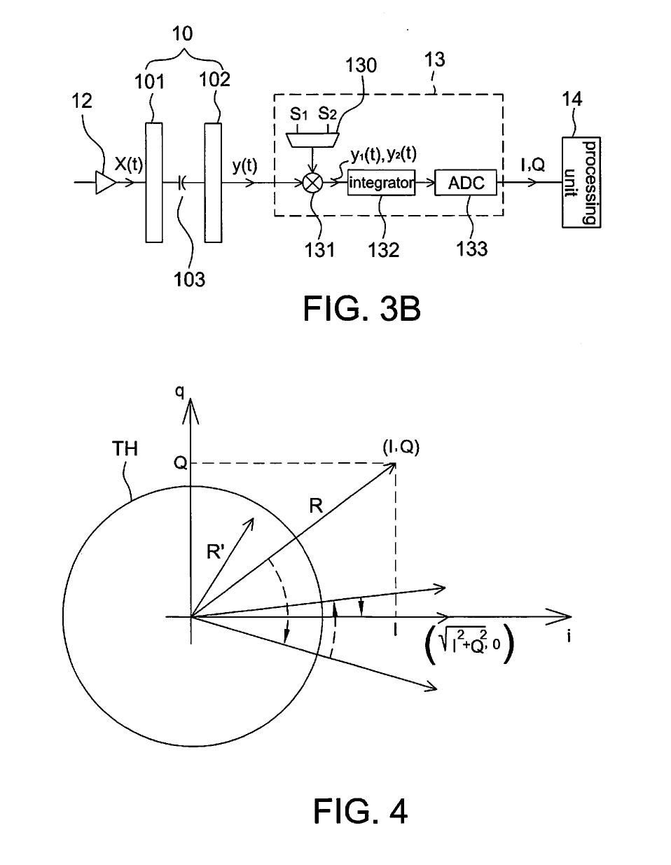

FIGS. 3A and 3B are schematic diagrams of the capacitive touch sensing device according to some embodiments of the present disclosure in which different implementations of a detection circuit 13 are shown.

In FIG. 3A, the detection circuit 13 includes two mixers 131 and 131′, two integrators 132 and 132′ and two analog to digital converters (ADC) 133 and 133′ configured to process a detection signal y(t) to generate a two-dimensional detection vector (I,Q). The two mixers 131 and 131′ are configured to modulate (or mix) the detection signal y(t) with two mixing signals, such as S₁=\sqrt{2/T}cos(cot) and s₂=\sqrt{2/T}sin(cot) herein, so as to generate a pair of modulated detection signals y₁(t) and y₂(t). In order to sample the pair of modulated detection signals yₗ(t) and y₂(t), two integrators 132 and 132′ are employed to integrate (or accumulate) the pair of modulated detection signals y₁(t) and y₂(t). In this embodiment, the two integrators 132 and 132′ are any proper integration circuits, such as capacitors, without particular limitations. The two ADC 133 and 133′ are used to digitize the pair of modulated detection signals y₁(t) and y₂(t) being accumulated so as to generate two digital components I and Q of the two-dimensional detection vector. It is appreciated that the two ADC 133 and 133′ start to acquire digital data when voltages on the two integrators 132 and 132′ are stable. In addition to the two continuous signals mentioned above, the two mixing signals are selected as two vectors, for example S₁=[1 0 −1 0] and S₂=[0 −1 0 1], so as to simplify the circuit structure. The two mixing signals are selected from simplified vectors without particular limitations as long as processes of modulation and demodulation are simplified.

In FIG. 3B, the detection circuit 13 includes a mixer 131, an integrator 132 and an analog to digital converter 133, and the two mixing signals S₁ and S₂ are inputted to the mixer 131 via a multiplexer 130 to be modulated with the detection signal y(t) so as to generate two modulated detection signals y₁(t) and y₂(t). In addition, functions of the mixer 131, the integrator 132 and the ADC 133 are similar to those shown in FIG. 3A and thus details thereof are not repeated herein.

As mentioned above, a detection method of the capacitive touch sensing device of the present disclosure includes the steps of: providing a drive signal to a first electrode of a sensing element; modulating a detection signal coupled to a second electrode from the drive signal through a coupling capacitance respectively with two mixing signals so as to generate a pair of modulated detection signals; and calculating a scale of the pair of modulated detection signals to accordingly identify a touch event.

Referring to FIG. 3A or 3B for example, the drive circuit 12 provides a drive signal x(t) to the first electrode 101 of the sensing element 10, and the drive signal x(t) couples a detection signal y(t) on the second electrode 102 of the sensing element 10 through the coupling capacitance 103. Next, the detection circuit 13 respectively modulates the detection signal y(t) with two mixing signals S₁ and S₂ to generate a pair of modulated detection signals y₁(t) and y₂(t). The processing unit 14 calculates a scale of the pair of modulated detection signals Mt) and y₂(t) to accordingly identify a touch event, wherein methods of calculating the scale of the pair of modulated detection signals y₁(t) and y₂(t) and comparing the pair of modulated detection signals y₁(t) and y₂(t) with at least one threshold may be referred to FIG. 4 and its corresponding descriptions. In addition, before the scale of the pair of modulated detection signals y₁(t) and y₂(t) is calculated, the integrator 132 and/or 132′ are operable to accumulate the pair of modulated detection signals y₁(t) and y₂(t) and then the ADC 133 and/or 133′ are operable to perform the digitization so as to output two digital components I and Q of the two-dimensional detection vector (I,Q).

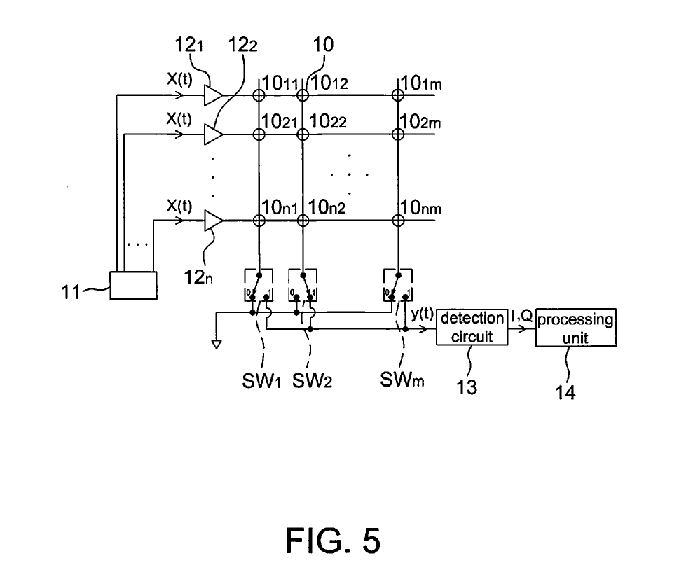

Referring to FIG. 5, it is a schematic diagram of a capacitive touch system according to a first embodiment of the present disclosure. A plurality of sensing elements 10 arranged in matrix form a capacitive sensing matrix in which each row of the sensing elements 10 is driven by one of the drive circuits 12₁-12ₙ and the detection circuit 13 detects output signals y(t) of every column of the sensing elements 10 through a plurality of switch devices SW_{I}-SWᵢₙ. As shown in FIG. 5, the drive circuit 12₁ is configured to drive the first row of sensing elements 10₁₁-10₁ₘ; the drive circuit 12₂ is configured to drive the second row of sensing elements 10₂₁-10₂ₘ; . . . ; and the drive circuit 12ₙ is configured to drive the nth row of sensing elements 10ₙ₁-10ₙₘ; wherein, n and m are positive integers and values thereof are determined according to the size and resolution of the capacitive sensing matrix without particular limitations.

In this embodiment, each of the sensing elements 10 (shown by circles herein) includes a first electrode and a second electrode configured to form a coupling capacitance therebetween as shown in FIGS. 2, 3A and 3B. The drive circuits 12₁-12ₙ are respectively coupled to the first electrode of a row of the sensing elements 10. For example, a timing controller 11 is operable to control the drive circuits 12₁-12ₙ to respectively output a drive signal x(t) to the first electrode of the sensing elements 10.

The detection circuit 13 is coupled to the second electrode of a column of the sensing elements 10 through a plurality of switch devices SW₁-SWₘ to sequentially detect a detection signal y(t) coupled to the second electrode from the drive signal x(t) through the coupling capacitance of the sensing elements 10. The detection circuit 13 respectively modulates the detection signal y(t) with two mixing signals to generate a pair of modulated detection signals, wherein details of generating the pair of modulated detection signals have been described in FIGS. 3A to 3B and corresponding descriptions and thus are not repeated herein.

The processing unit 14 identifies a touch event and a touch position according to the pair of modulated detection signals. As mentioned above, the processing unit 14 calculates a norm of vector of a two-dimensional detection vector formed by the pair of modulated detection signals and identifies the touch event when the norm of vector exceeds a threshold TH as shown in FIG. 4.

In this embodiment, when the timing controller 11 controls the drive circuit 12₁ to output the drive signal x(t) to the first row of the sensing elements 10₁₁-10₁ₘ, the switch devices SW₁-SWₘ are sequentially turned on such that the detection circuit 13 detects the detection signal y(t) sequentially outputted by each sensing element of the first row of the sensing elements 10₁₁-10₁ₘ. Next, the timing controller 11 sequentially controls other drive circuits 12₂-12n to output the drive signal x(t) to every row of the sensing elements. When the detection circuit 13 detects all of the sensing elements, a scan period is accomplished. The processing unit 14 identifies the position of the sensing elements that the touch event occurs as the touch position. It is appreciated that said touch position may be occurred at more than one sensing elements 10 and the processing unit 14 takes all positions of a plurality of sensing elements 10 as touch positions or takes one of the positions (e.g. a center or gravity center) of a plurality of sensing elements 10 as the touch position.

In another embodiment, to save the power of the capacitive touch system in FIG. 5, the timing controller 11 controls at least a part of the drive circuits 12₁-12ₙ to concurrently output the drive signal x(t) to the corresponded sensing elements. The detection circuit 13 modulates the detection signal y(t) at each row with different two mixing signals S₁ and S₂, respectively. In addition, methods of identifying a touch event and a touch position are similar to FIG. 5, and thus details thereof are not repeated herein.

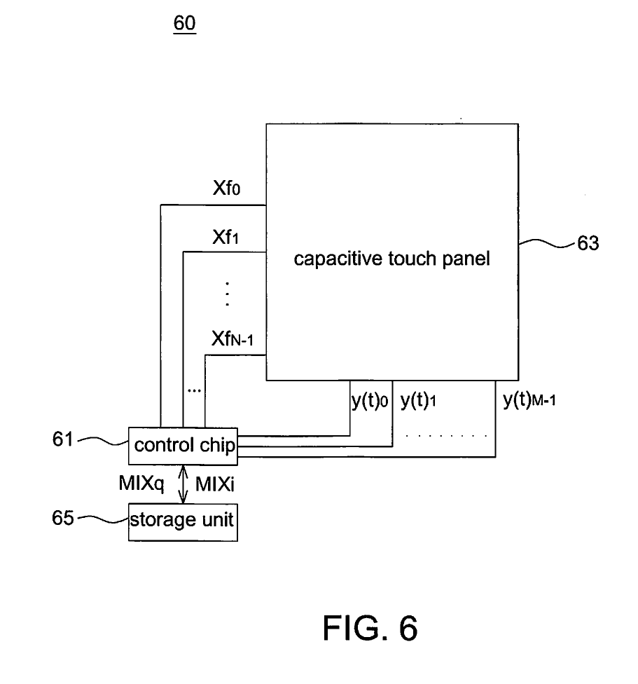

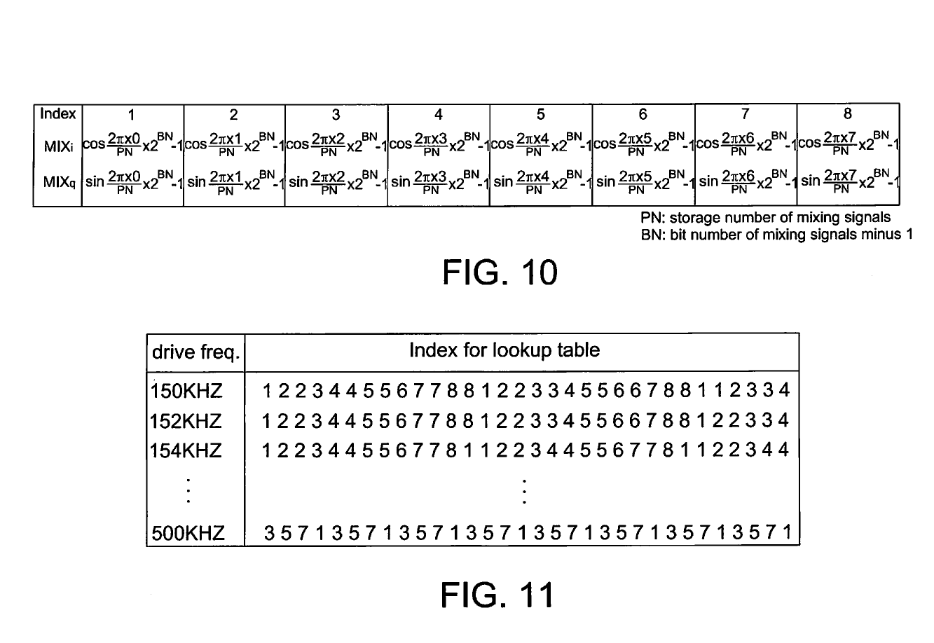

Referring to FIG. 6, it is a schematic block diagram of a capacitive touch system according to a second embodiment of the present disclosure. The capacitive touch system 60 includes a control chip 61, a capacitive touch panel 63 and a storage element 65. The storage element 65 is, for example, a nonvolatile memory or a buffer, and configured to previously store a lookup table (as shown in FIG. 10 for example) which includes a plurality of mixing signals MIXi and MIXq. In some embodiments, the lookup table contains a generating algorithm of sine signals and/or cosine signals for the control chip 61 to generate mixing signals MIXi and MIXq corresponding to different drive frequencies. In some embodiment, the storage . 10 element 65 previously stores at least one formula instead of the lookup table, and the at least one formula is used to generate mixing signals MIXi and MIXq corresponding to different drive frequencies.

It should be mentioned that although FIG. 10 shows that the lookup table contains both sine signals and cosine signals, the present disclosure is not limited thereto. In other embodiments, the lookup table includes one of sine signals or cosine signals, and the control chip 61 generates a plurality pairs of sine and cosine signals configured as a pair of mixing signals by phase shifting (e.g. 90 degrees phase shifting).

It should be mentioned that although FIG. 10 shows that the lookup table contains 8 pairs of mixing signals MIXi and MIXq, the present disclosure is not limited thereto. In other embodiments, the lookup table contains 2^{P} pairs of mixing signals, wherein P is a positive integer larger than 2.

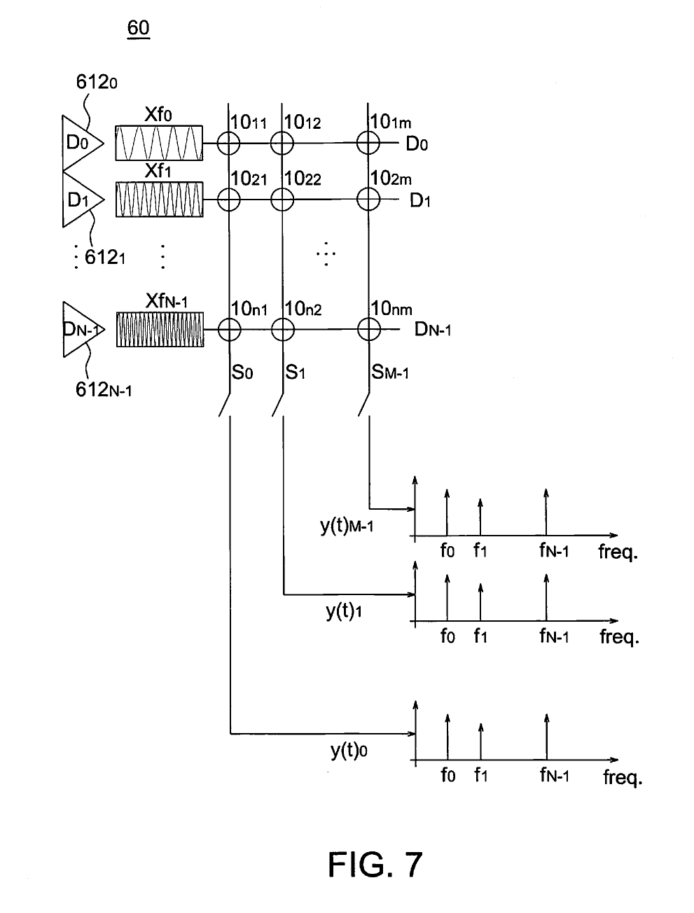

Referring to FIG. 7, it is an operational schematic diagram of a capacitive touch system according to a second embodiment of the present disclosure. The capacitive touch system 60 includes a plurality of drive circuits 612₀-612_{N-1} respectively configured to output a drive signal Xf₀-Xf_{N-1} to a plurality of drive electrodes D₀-D_{N-1}, wherein drive frequencies f₀-f_{N-1} of the drive signals Xf₀-Xf_{N-1} are different from one another. The capacitive touch system 60 further includes a plurality of receiving electrodes S₀-S_{M-1} respectively configured to output detection signals y(t)₀-y(t)_{M-1}, wherein each of the detection signals y(t)₀-y(t)_{M -1} contains frequency components f₀-f_{N-1} of the drive signals Xf₀-V_{N-1}.

The control chip 61 concurrently drives the capacitive touch panel 63 with a plurality of frequency division multiplexed (FDM) drive signals Xf₀-Xf_{N-1} to generate a plurality of detection signals y(t)₀-y(t)_{M-1}, and determines a plurality pairs of mixing signals MIXi and MIXq to respectively modulate the detection signals y(t)₀-y(t)_{M-1} to generate a plurality pairs of modulated detection signals (illustrated by an example hereinafter), wherein the pairs of mixing signals MIXi and MIXq corresponding to different drive signals Xf₀-Xf_{N-1} are different from one another, and two signals of the pair of mixing signals MIXi and MIXq corresponding to each of the drive signals Xf₀-Xf_{N-1} are orthogonal to each other. It should be mentioned that the mixing signals MIXi and MIXq are not limited to those shown in FIG. 10 as long as the two signals of each pair of mixing signals are orthogonal to each other.

Referring to FIG. 11, it is an index table of mixing signals corresponding to different drive frequencies f₀-f_{N-1} in a capacitive touch system according to a second embodiment of the present disclosure. In one embodiment, the drive frequencies f₀-f_{N-1} of the drive signals Xf₀-Xf_{N-1} are, for example, 150 kHZ, 152 kHz, 154 kHz, . . . The control chip 61 previously sets a predetermined algorithm to respectively determine a set of indexes corresponding to each of the drive frequencies f₀-f_{N-1} to accordingly select corresponding mixing signals MIXi and MIXq from the lookup table. For example, when the index is 1, a pair of mixing signals cos(2π×0/PN)×2^{BN}−1 and sin(2π×0/PN)×2^{BN}−1 are selected; when the index is 2, a pair of mixing signals cos(2π×1/PN)×2^{BN}−1 and sin(2π×1/PN)×2^{BN}−1 are selected; when the index is 3, a pair of mixing signals cos(2π×2/PN)×2^{BN}−1 and sin(2π×2/PN)×2^{BN}−1 are selected; and so on, wherein PN is a storage number (e.g. 8 shown herein) of the mixing signals in the lookup table, and BN is a bit number of the mixing signals minus 1.

For example, MIXi and MIXq for modulating the detection signal y(t) respectively include 32 digital components in FIG. 11. For example, MIXi corresponding to the drive frequency 150 kHz includes an array [cos(2π×0/PN)×2^{BN}−1, cos(2π×1/PN)×2^{BN}−1, cos(2π×1/PN)×2^{BN}−1, cos(2π×2/PN)×2^{BN}−1, cos(2π×3/PN)×2^{BN}−1, cos(2π×3/PN)×2^{BN}−1, . . . , cos(2π×2/PN)×2^{BN}−1, cos(2π×2/PN)×2^{BN}−1, cos(2π×3/PN)×2^{BN}−1]; MIXq corresponding to the drive frequency 150 kHz includes an array [sin(2π×0/PN)×2^{BN}−1, sin(2π×1/PN)×2^{BN}−1, sin(2π×1/PN)×2^{BN}−1, sin(2π×2/PN)×2^{BN}−1, sin(2π×3/PN)×2^{BN}−1, sin(2π×3/PN)×2^{BN}−1, . . . , sin(2π×2/PN)×2^{BN}−1, sin(2π×2/PN)×2^{BN}−1, sin(2π×3/PN)×2^{BN}−1]. It is appreciated that numbers of the digital components included in MIXi and MIXq, PN, BN or other values shown in FIGS. 10-11 are intended to illustrate but not to limit the present disclosure.

As mentioned above, it is possible that each index corresponds to one of a pair of mixing signals, and the control chip 61 calculates another mixing signal according to the phase shift, e.g. 90 degrees phase shift.

The control chip 61 further calculates a norm of vector of each pair of modulated detection signals, and compares the norm of vector with at least one threshold to identify a touch event, as shown in FIG. 4.

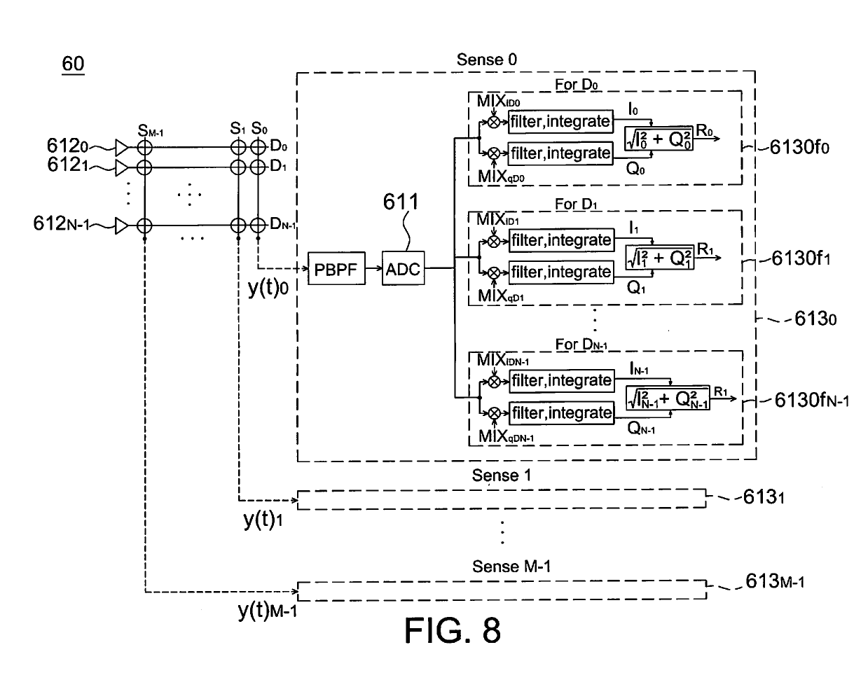

Referring to FIG. 8, it is another schematic block diagram of a capacitive touch system according to a second embodiment of the present disclosure. The capacitive touch system 60 includes a plurality of drive electrodes D₀-D_{N-1}, a plurality of receiving electrodes S₀-S_{M-1} and a control chip 61 (as shown in FIG. 6). The control chip 61 includes a plurality of drive circuits 612₀-612_{N-1}, a plurality of analog to digital converters (ADC) 611, a plurality of detection circuit sets 613₀-613_{M-1} and a processing unit 614 (as shown in FIG . 9), wherein a number of the detection circuit sets 613₀-613_{M-1} is identical to a number of the receiving electrodes S₀-S_{M-1}, and each of the detection circuit sets 613₀-613_{M-1} includes a plurality of detection circuits (e.g. the detection circuit set 613₀ includes detection circuits 6130f₀-6130f_{N-1}). In this embodiment, a circuit number of the detection circuits coupled to each of the receiving electrodes S₀-S_{M-1} is equal to a frequency number of the drive frequencies f₀-f_{M-1} so as to decouple every drive frequency. That is, a circuit number of the detection circuits included in each of the detection circuit sets 613₀-613_{M-1} is equal to a frequency number of the drive frequencies f₀-f_{M-1}.

As mentioned above, the drive electrodes D₀-D_{N-1} and the receiving electrodes S₀-S_{M-1} are configured to form a plurality of sensing elements therebetween, e.g. 10₁₁-10ₙₘ. The drive circuits 612₀-612_{N-1} are respectively coupled to the drive electrodes D₀-D_{N-1}, and configured to concurrently output a plurality of drive signals Xf₀-Xf_{N-1} to the drive electrodes D₀-D_{N-1}, wherein the drive frequencies f₀-f_{N-1} of the drive signals Xf₀-Xf_{N-1} outputted by different drive circuits 612₀-612_{N-1} are different from one another, as shown in FIG. 7. The receiving electrodes S₀-S_{M-1} are respectively configured to induce and output detection signals y(t)₀-y(t)_{M-1} according to the drive signals Xf₀-V_{N-1}.

The ADCs 611 are configured to convert the detection signals y(t)₀-y(t)_{M-1} into digital signals. For example, the ADCs 611 are respectively coupled between the receiving electrodes S₀-S_{M-1} and the detection circuits. More specifically speaking, each of the ADCs 611 is coupled between one receiving electrode and a plurality of detection circuits included in one detection circuit sets 613₀-613_{M-1} as shown in FIG. 8.

The detection circuits (e.g. 6130f₀-6130f_{N-1}) are respectively coupled to the receiving electrodes S₀-S_{M-1}, e.g. via an ADC 611 and a programmable band pass filter (PBPF). Each of the detection circuits includes two mixers configured to modulate a detection signal y(t)₀-y(t)_{M-1} outputted by the coupled receiving electrode S₀-S_{M-1} with a pair of mixing signals MIXi and MIXq to generate a pair of modulated detection signals (I₀Q₀)-(I_{N-1},Q_{N-1}). For example, the detection circuit 6130f₀ includes two mixers configured to mix a pair of mixing signals MIX_{iD0} and MIX_{qD0} to the detection signal y(t)₀ to generate a pair of modulated detection signal (I₀,Q₀); the detection circuit 6130f₁ includes two mixers configured to mix a pair of mixing signals MIX_{iD1} and MIX_{qD1} to the detection signal y(t)₀ to generate a pair of modulated detection signal (I_{I},Q₁); and so on. The implementation of other detection circuit sets 613₁-613_{M-1} is similar to that of the detection circuit set 613₀ and thus details thereof are not repeated herein. For example, MIX_{iD0} and MIX_{qD0} are selected according to indexes corresponding to 150 kHz shown in FIG. 11; MIX_{iD1} and MIX_{qD1} are selected according to indexes corresponding to 152 kHz shown in FIG. 11; and so on.

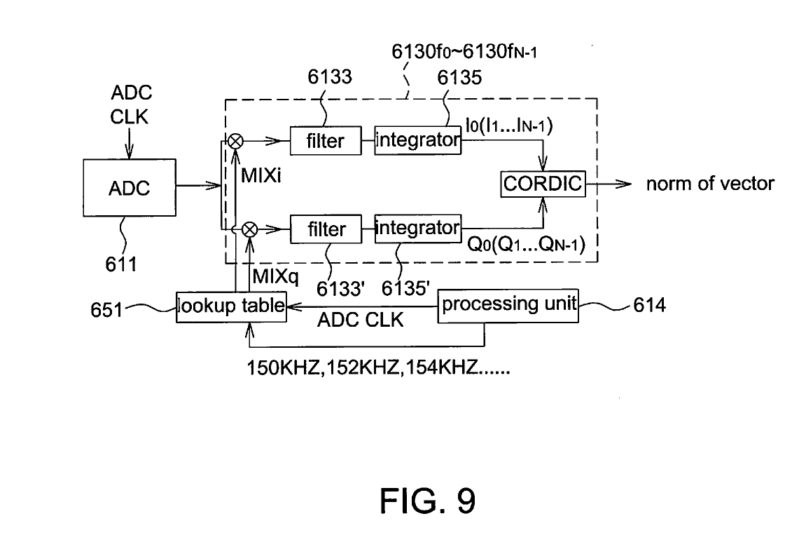

Referring to FIG. 9, it is another schematic block diagram of a capacitive touch system according to a second embodiment of the present disclosure. The processing unit 614 is configured to select the pair of mixing signals MIXi and MIXq corresponding to each of the detection circuits from a lookup table 615 (e.g. previously stored in the storage element 65) according to the drive frequencies f₀-f_{N-1}, and calculate a norm of vector of the pair of modulated detection signals to identify a touch event. For example, the processing unit 614 selects a pair of mixing signals MIX_{iD0} and MIX_{qD0} corresponding to the detection circuit 6130f₀ from the lookup table 615 according to the drive frequency f₀ associated with the detection circuit 6130f₀, and calculate a scale (I₀²+Q₀²)^{1/2} of a pair of modulated detection signals I₀ and Q₀; the processing unit 614 selects a pair of mixing signals MIX_{iD1} and MIX_{qD1} corresponding to the detection circuit 6130f₁ from the lookup table 615 according to the drive frequency f₁ associated with the detection circuit 6130f₁, and calculate a scale (I₁²+Q₁²)^{1/2} of a pair of modulated detection signals I₁ and Q₁; and so on.

To improve the signal quality of the modulated detection signals (I₀,Q₀)-(I_{N-1}-Q_{N-1}), in some embodiments each of the detection circuits (e.g. 6130f₀-6130f_{N-1}) further includes two filters 6133 and 6133′ configured to filter a pair of modulated detection signals, respectively. In some embodiments, the filters 6133 and 6133′ are Nyquist filters, but not limited thereto.

In order to sample the modulated detection signals, each of the detection circuits (e.g. 6130f₀-6130f_{N-1}) further includes two integrators 6135 and 6135′ configured to accumulate a plurality of modulated detection signals within one drive slot.

It should be mentioned that although FIG. 8 shows details of only the detection circuit set 613₀, as other detection circuit sets 613₁-613/_{M-1} are similar to the detection circuit set 613₀ and only the detection signals being modulated are different (the used mixing signals being different or identical), details of the other detection circuit sets 613₁-613_{M-1} are not repeated herein, e.g. the detection signal y(t)₀ is processed by the detection circuit set 613₀, the detection signal y(t)₁ is processed by the detection circuit set 613₁, and so on. In addition, in the present disclosure functions of the drive circuits 612₀-612_{N-1}, the detection circuit sets 613₀-613_{M-1}, the analog to digital converters 611 and the processing unit 614 are considered to be executed by the control chip 61 with software, firmware and/or hardware.

It should be mentioned that although FIG. 9 respectively shows the processing unit 614 and the detection circuits 6130f₀-6130f_{N-1}, but the present disclosure is not limited thereto. In some embodiments, the detection circuits are included in the processing unit 614. More specifically speaking, the detection circuit sets 613₁-613_{M-1} shown in FIG. 8 are a partial circuit of the processing unit 614.

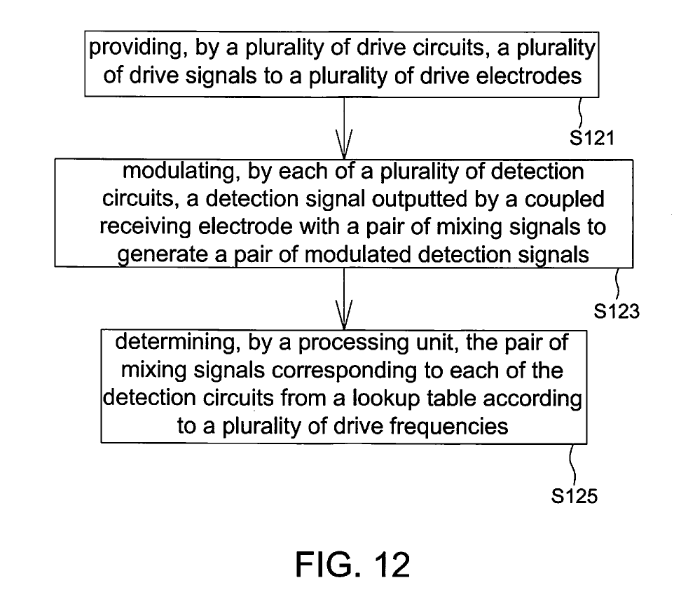

Referring to FIG. 12, it is an operating method of a capacitive touch system according to a second embodiment of the present disclosure, which includes the steps of: concurrently providing, by a plurality of drive circuits 612₀-612_{N-1}, a plurality of drive signals Xf₀-Xf_{N-1} to a plurality of drive electrodes D₀-D_{N-1} (Step S121); modulating, by each of a plurality of detection circuits, a detection signal y(t)₀-y(t)_{M-1} outputted by a coupled receiving electrode S₀-S_{M-1} with a pair of mixing signals MIXi and MIXq to generate a pair of modulated detection signals I and Q (Step S123); and determining, by a processing unit 614, the pair of mixing signals MIXi and MIXq corresponding to each of the detection signals from a lookup table 651 according to a plurality of drive frequencies f₀-f_{N-1} (Step S125). As mentioned above, the plurality of drive frequencies f₀-f_{N-1} of the drive signals Xf₀-Xf_{N- 1} outputted by different drive circuits 612₀-612_{N-1} are different from one another so as to implement FDM scheme.

In addition, as mentioned above the processing unit 614 calculates a norm of vector of the pair of modulated detection signals I and Q to accordingly identify a touch event according to a comparison between the norm of vector and at least one threshold. Meanwhile, the processing unit 614 further performs gesture recognition or other applications according to the variation of touch positions determined in different scan periods.

In addition, before signal mixing, the control chip 61 further converts the detection signals y(t)₀-y(t)_{M-1} to digital signals through an analog to digital converter 611. In other words, in the present disclosure, the detection circuit sets 613₀-613_{M-1} process digital data.

In addition, to well use the dynamic range of the analog to digital converter 611, a phase shift is arranged between the drive signals Xf₀-Xf_{N-1} corresponding to different drive frequencies f₀-f_{N-1} so as reduce peak-to-peak values of the detection signals y(t)₀-y(t)_{M-1}. The phase shift is selected from, for example, the random phase offset or formulated phase offset, but not limited thereto. In brief, as long as a phase shift is formed between the drive signals Xf₀-Xf_{N-1} corresponding to different drive frequencies f₀-f_{N-1}, the selection of the phase shift is implemented without particular limitations.

The control chip 61 further filters the pair of modulated detection signals I and Q with digital filters, e.g. Nyquist filters, so as to improve the signal quality and improve the detection accuracy.

The control chip 61 further accumulates a plurality of modulated detection signals I and Q within one drive slot using the integrators to perform the signal sampling. In the present disclosure, the control chip 61 samples the modulated detection signals I and Q within only one drive slot rather than samples the modulated detection signals I and Q for a plurality of drive slots so as to decrease the sampling interval.

Details of the operating method have been illustrated above, and thus details thereof are not repeated herein.

In other embodiments, the control chip 61 drives the drive electrodes D₀-D_{N-1} with FDM scheme and calculates the fast Fourier transformation (FFT) of detection signal y(t)₀-y(t)_{M-1} outputted by each of the receiving electrodes S₀-S_{M-1} so as to determine a spectral energy corresponding to each of the drive frequencies f₀-f_{N-1}, and identifies a touch event according to the spectral energy. For example, the control chip 61 compares the spectral energy with at least one threshold, and a touch event is identified when the spectral energy exceeds a predetermined threshold.

In some embodiments, only a part of the drive frequencies f₀-f_{N-1} corresponding to the drive signals Xf₀-Xf_{N-1} are different from one another but some of the drive frequencies f₀-f_{N-1} are identical. In other words, a number of the drive frequencies adopted by the capacitive touch system 60 is less than a number of the drive signals Xf₀-V_{N-1}.

As mentioned above, when capacitive sensors are applied to different electronic devices, they are interfered by the noise of the electronic devices to degrade the detection accuracy. Therefore, the present disclosure further provides a capacitive touch system (FIGS. 6-9) and an operating method thereof (FIGS. 12) that generate drive signals by frequency division multiplexing to perform the concurrent drive and determine a pair of mixing signals corresponding to different drive frequencies through checking a lookup table. The drive frequencies are selected in the frequency gaps having lower noise interference, and the phase shift due to different loading and trace lengths are cancelled by calculating the norm of vector so as to improve the detection accuracy.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

I 7

What is claimed is:

1. A capacitive touch system comprising:
a plurality of drive electrodes and a plurality of receiving electrodes configured to form a plurality of sensing elements therebetween;
a plurality of drive circuits respectively coupled to the drive electrodes and configured to concurrently output a plurality of drive signals to the drive electrodes, wherein a plurality of drive frequencies of the drive signals outputted by different drive circuits are different from one another;
a plurality of detection circuits respectively coupled to the receiving electrodes, each of the detection circuits comprising two mixers configured to modulate a detection signal outputted by the coupled receiving electrode with a pair of mixing signals to generate a pair of modulated detection signals; and
a processing unit configured to
determine the pair of mixing signals corresponding to each of the detection circuits according to the drive frequencies, and
calculate a norm of vector of the pair of modulated detection signals to accordingly identify a touch event.

2. The capacitive touch system as claimed in claim 1, wherein each of the detection circuits further comprises two filters configured to filter the pair of modulated detection signals, respectively.

3. The capacitive touch system as claimed in claim 1, wherein each of the detection circuits further comprises two integrators configured to accumulate a plurality of modulated detection signals within a drive slot.

4. The capacitive touch system as claimed in claim 1, wherein the pair of mixing signals is determined according to a lookup table and comprises a sine signal and a cosine signal.

5. The capacitive touch system as claimed in claim 1, wherein phase shifts are formed between drive signals corresponding to different drive frequencies based on a random phase offset or a formulated phase offset.

6. The capacitive touch system as claimed in claim 1, further comprising a plurality of analog to digital convertors respectively coupled between the receiving electrodes and the detection circuits.

7. The capacitive touch system as claimed in claim 1, wherein a circuit number of the detection circuits coupled to each of the receiving electrodes is identical to a frequency number of the drive frequencies.

8. A capacitive touch system comprising
a capacitive touch panel;
a storage element configured to previously store a plurality of mixing signals; and
a control chip configured to
concurrently drive the capacitive touch panel with a plurality of frequency division multiplexed drive signals to output a plurality of detection signals, and
read a plurality pairs of mixing signals from the storage element to respectively modulate the detection signals to generate a plurality pairs of modulated detection signals, wherein the pair of mixing signals corresponding to different drive signals are different from one another.

9. The capacitive touch system as claimed in claim 8, wherein the control chip is further configured to calculate a norm of vector of each pair of modulated detection signals.

10. The capacitive touch system as claimed in claim 8, wherein the storage element stores a lookup table, and the lookup table comprises a generating algorithm of a plurality of sine signals and/or a plurality of cosine signals for generating the mixing signals.

11. The capacitive touch system as claimed in claim 8, wherein the control chip further comprises a plurality of Nyquist filters configured to filter the modulated detection signals.

12. The capacitive touch system as claimed in claim 8, wherein the control chip further comprises a plurality of integrators configured to accumulate the modulated detection signals.

13. The capacitive touch system as claimed in claim 8, wherein the pair of mixing signals corresponding to each of the drive signals is orthogonal to each other.

14. The capacitive touch system as claimed in claim 8, wherein phase shifts are formed between drive signals based on a random phase offset or a formulated phase offset.

15. An operating method of a capacitive touch system, the capacitive touch system comprising a plurality of drive electrodes, a plurality of receiving electrodes, a plurality of drive circuits, a plurality of detection circuits and a processing unit, the operating method comprising:
providing, by the drive circuits, a plurality of drive signals to the drive electrodes, wherein at least a part of a plurality of drive frequencies of the drive signals outputted by different drive circuits are different from one another;
modulating, by each of the detection circuits, a detection signal outputted by the coupled receiving electrode with a pair of mixing signals to generate a pair of modulated detection signals; and
determining, by the processing unit, the pair of mixing signals corresponding to each of the detection signals according to the drive frequencies.

16. The operating method as claimed in claim 15, further comprises:
calculating, by the processing unit, a norm of vector of the pair of modulated detection signals; and
comparing the norm of vector with a threshold.

17. The operating method as claimed in claim 15, further comprising:
filtering the pair of modulated detection signals.

18. The operating method as claimed in claim 15, further comprising:
accumulating a plurality of modulated detection signals within a drive slot.

19. The operating method as claimed in claim 15, further comprising:
digitizing the detection signal.

20. The operating method as claimed in claim 15, wherein the pair of mixing signals is determined according to a lookup table and comprises a sine signal and a cosine signal.
